(19) United States
(12) Patent Application Publication
(10) Pub. No.: US 2017/0050298 A1
(43) Pub. Date: Feb. 23, 2017

(54) Adjustable Wrench with Bumper Structure

(71) Applicant: New Way Tools Co., Ltd., Taichung City (TW)

(72) Inventor: Ping-Wen Huang, Taichung City (TW)

(21) Appl. No.: 14/832,038

(22) Filed: Aug. 21, 2015

(51) Int. Cl. B25B 13/14

(52) U.S. Cl. CPC B25B 13/14

(57) ABSTRACT

An adjustable wrench includes a handle, a head, a movable jaw, a bumper member, and an adjusting assembly. The head is connected to the handle and includes a fixed jaw, a guiding slot, and a receiving slot interconnected with the guiding slot. The movable jaw is slidably connected to the guiding slot along an axis and includes a gripping portion, a guiding portion spaced from the gripping portion, and a first connecting portion formed in the guiding portion. The bumper member includes a bumper portion and a second connecting portion spaced from the bumper portion. The second connecting portion is detachably connected to the first connecting portion. The adjusting assembly is positioned in the receiving slot and includes a worm gear engaged with the guiding portion.

### BACKGROUND

The present invention relates to an adjustable wrench and, more particularly, to an adjustable wrench with a bumper structure to absorb impact in a collision.

U.S. Pat. No. 8,136,429 discloses a reversible monkey wrench, which includes a handle, a head, a slidable jaw, an axial rod and a worm gear. The handle has a connecting end for the head to abut thereagainst. The head is formed with a fixed jaw, a sliding rail, a receiving slot and a connecting bore. The connecting bore communicates with the receiving slot. A movable pin and a spring are disposed between the connecting end and the head. A top of the movable pin selectively inserts through the connecting bore. The spring urges the movable pin so that the movable pin may abut against the connecting end. The worm gear is adapted to control the slidable jaw to move and is slidably disposed in the receiving slot with respect to the axial rod. The movable pin selectively abuts against the worm gear to prohibit the worm gear from sliding.

However, when the reversible monkey wrench turns a workpiece, the slidable jaw may collide with the obstacle, such as the machine or the hole wall to damage the slidable jaw or the obstacle.

Thus, a need exists for an adjustable wrench with a bumper structure to avoid the drawbacks of the conventional structure.

### BRIEF SUMMARY

An adjustable wrench according to the present invention include a handle, a head, a movable jaw, a bumper member, and an adjusting assembly. The head is connected to an end of the handle and includes a fixed jaw, a guiding slot, and a receiving slot interconnected with the guiding slot. The movable jaw is slidably connected to the guiding slot along an axis and includes a first side and a second side spaced from the first side. The first side faces to the fixed jaw. The movable jaw further includes a gripping portion, a guiding portion spaced from the gripping portion, and a first connecting portion formed in the guiding portion and located at the second side. The bumper member includes a bumper portion and a second connecting portion spaced from the bumper portion. The second connecting portion is detachably connected to the first connecting portion of the movable jaw. The adjusting assembly is positioned in the receiving slot of the head and includes a worm gear. The worm gear is engaged with the guiding portion of the movable jaw.

In an example, the bumper member is made of a nonmetal material.

In another example, the bumper member is made of an elastic material.

The bumper portion and the second connecting portion are connected with each other in one piece.

The guiding portion of the movable jaw includes a first width extending along the axis, and the bumper portion of bumper member includes a second width extending along the axis. The first width is greater than the second width.

In an example, the ratio of the first width to the second width is not less than 5.5.

In another example, the ratio of the first width to the second width is not less than 5.

The first connecting portion of the movable jaw is a hole and extends from the second side to the first side.

The second connecting portion of the bumper member is a protrusion extending from the bumper portion and corresponds to the first connecting portion.

The first connecting portion includes a first threaded section formed around an inner periphery thereof, and the second connecting portion includes a second threaded section formed around an outer periphery thereof and corresponds to the first threaded section. The second threaded section is detachably engaged with first threaded section.

The bumper portion has a semicircular cross section perpendicular to the axis.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of an adjustable wrench of a first embodiment according to the present invention.

FIG. 2 is a partial, exploded, perspective view of the adjustable wrench of FIG. 1.

FIG. 3 is a partial, cross sectional view of the adjustable wrench of FIG. 1.

FIG. 4 is another partial, cross sectional view of the adjustable wrench of FIG. 1, illustrating fixed and movable jaws together gripping a workpiece near a machine.

FIG. 5 is a continued view of the adjustable wrench of FIG. 4, illustrating a bumper member colliding with the machine to absorb impact.

FIG. 6 is a partial, exploded, perspective view of the adjustable wrench of a second embodiment according to the present invention.

FIG. 7 is a side view of the adjustable wrench of a third embodiment according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “outer”, “top”, “bottom”, “side”, “end”, “portion”, “section”, “longitudinal”, “radial”, “height”, and similar terms are used herein, it should be understood that these terms have reference only to the structure shown in the drawings as it would appear to a person viewing the drawings and are utilized only to facilitate describing the illustrative embodiment.

### DETAILED DESCRIPTION

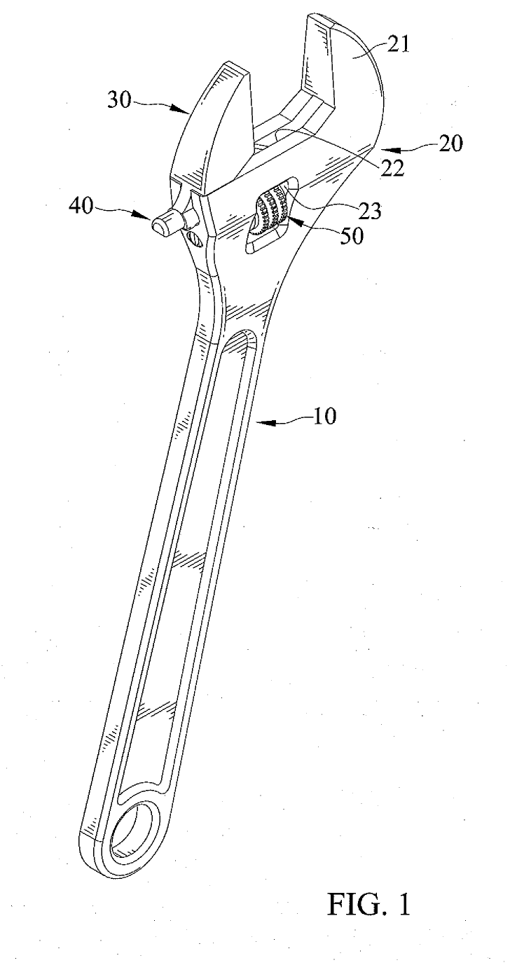

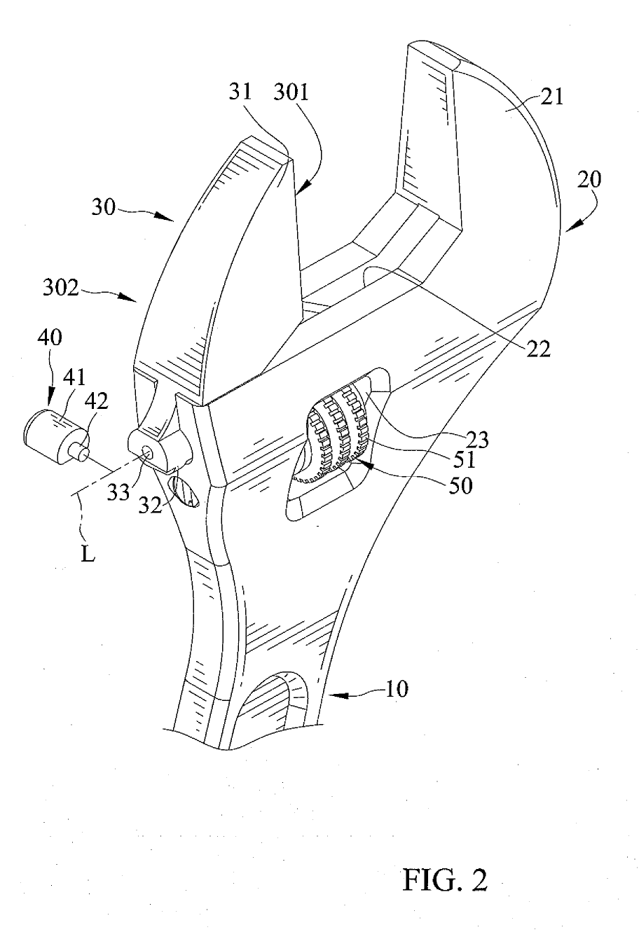

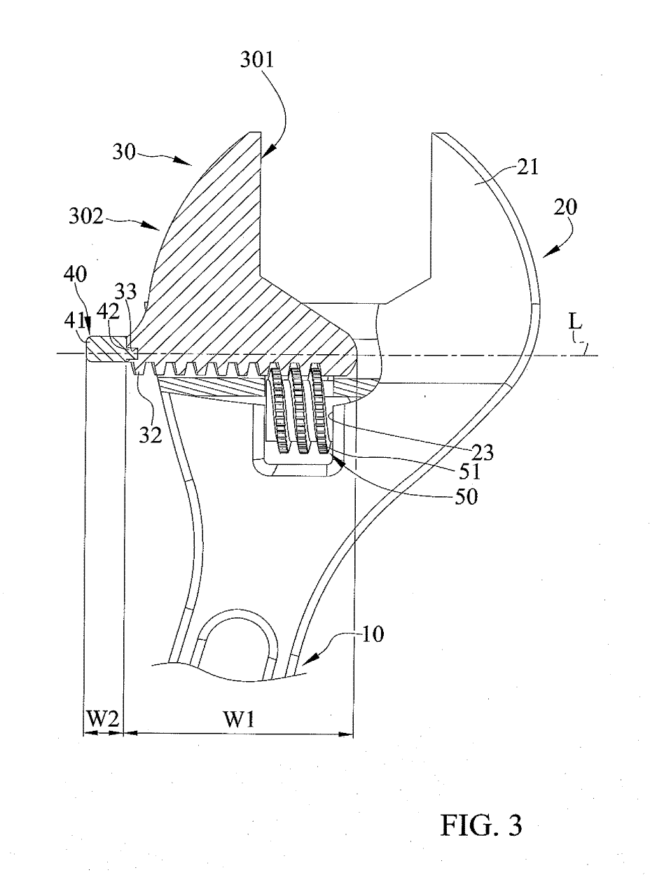

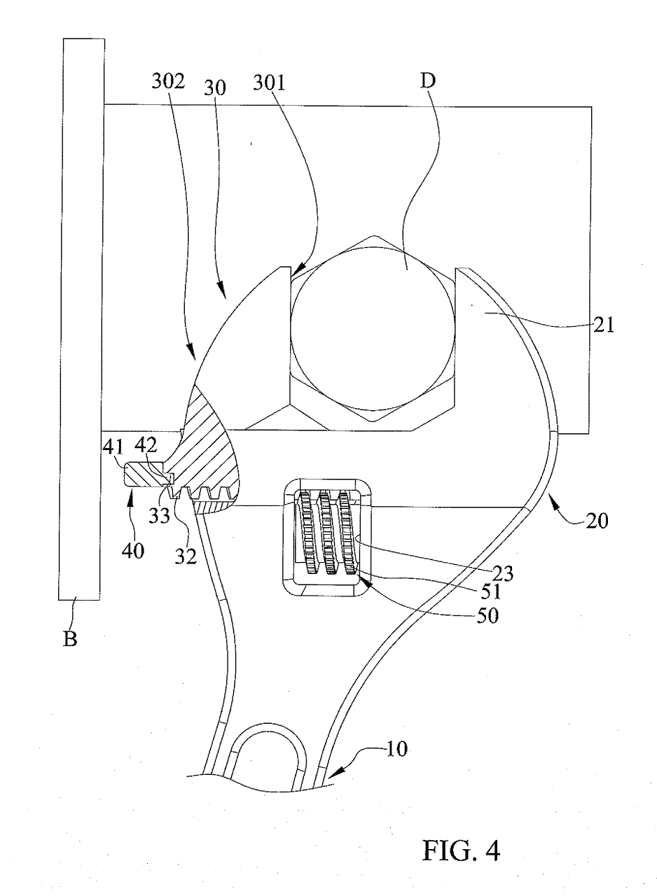

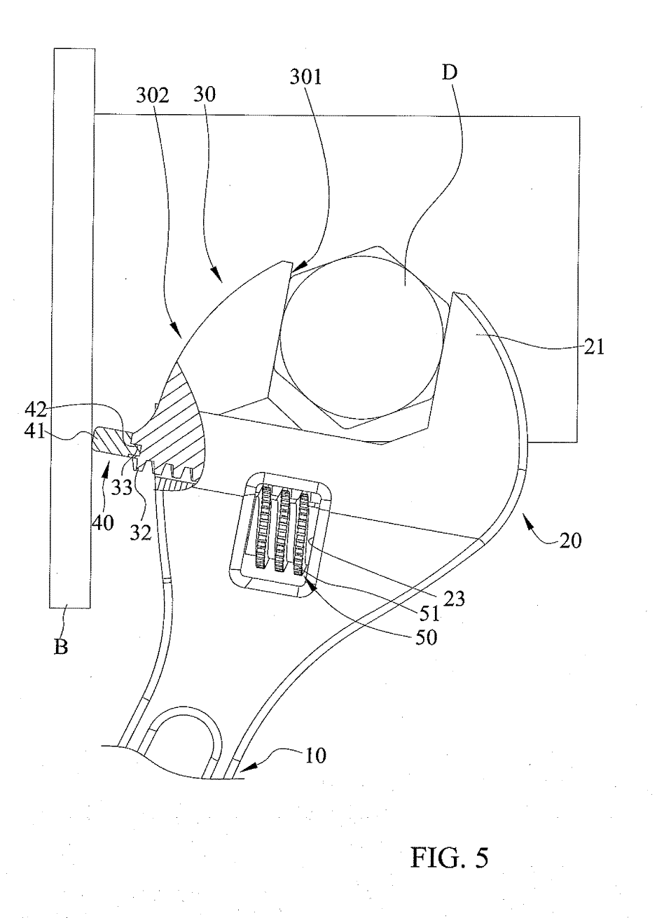

FIGS. 1-5 show an adjustable wrench of a first embodiment according to the present invention. The adjustable wrench includes a handle 10, a head 20, a movable jaw 30, a bumper member 40, and an adjusting assembly 50.

The head 20 is connected to an end of the handle 10. Preferably, the head 20 and the handle 10 are integrally made of a metal material. The head 20 includes a fixed jaw 21, a guiding slot 22, and a receiving slot 23 interconnected with the guiding slot 22.

The movable jaw 30 is slidably connected to the guiding slot 22 of the head 20 along an axis L. Preferably, the movable jaw 30 may be made of a metal material. The movable jaw 30 includes a first side 301 and a second side 302 spaced from the first side 301. The first side 301 faces to the fixed jaw 21 of the head 20. The movable jaw 30 further includes a gripping portion 31, a guiding portion 32 spaced from the gripping portion 31, and a first connecting portion 33 formed in the guiding portion 32 and located at the second side 302. The guiding portion 32 includes a first width W1 extending along the axis L. In the embodiment, the first connecting portion 33 is a hole and extends from the second side 302 to the first side 301.

The bumper member 40 includes a bumper portion 41 and a second connecting portion 42 spaced from the bumper portion 41. The second connecting portion 42 is detachably connected to the first connecting portion 33 of the movable jaw 30. In the embodiment, the bumper member 40 is made of a nonmetal material, and more preferably is made of an elastic material adapted to absorb impact in a collision. The bumper portion 41 and the second connecting portion 42 are connected with each other in one piece. The bumper portion 41 has a semicircular cross section perpendicular to the axis L. The bumper portion 41 includes a second width W2 extending along the axis L. The first width W1 of the guiding portion 32 is greater than the second width W2 of the bumper portion 41. The ratio of the first width W1 to the second width W2 is not less than 5.5, and more preferably is not less than 5. In the embodiment, the second connecting portion 42 is a protrusion extending from the bumper portion 41 and corresponds to the first connecting portion 33 of the movable jaw 30.

The adjusting assembly 50 is positioned in the receiving slot 23 of the head 20 and includes a worm gear engaged with the guiding portion 32 of the movable jaw 30 for adjusting an open size between fixed jaw 21 and movable jaw 30.

Thus, when the fixed jaw 21 and movable jaw 30 together grip and turn a workpiece D near an obstacle B, such as the machine or the hole wall, the bumper portion 41 of the bumper member 40 can collide with the obstacle B to absorb accidental impact between the bumper member 40 and the obstacle B.

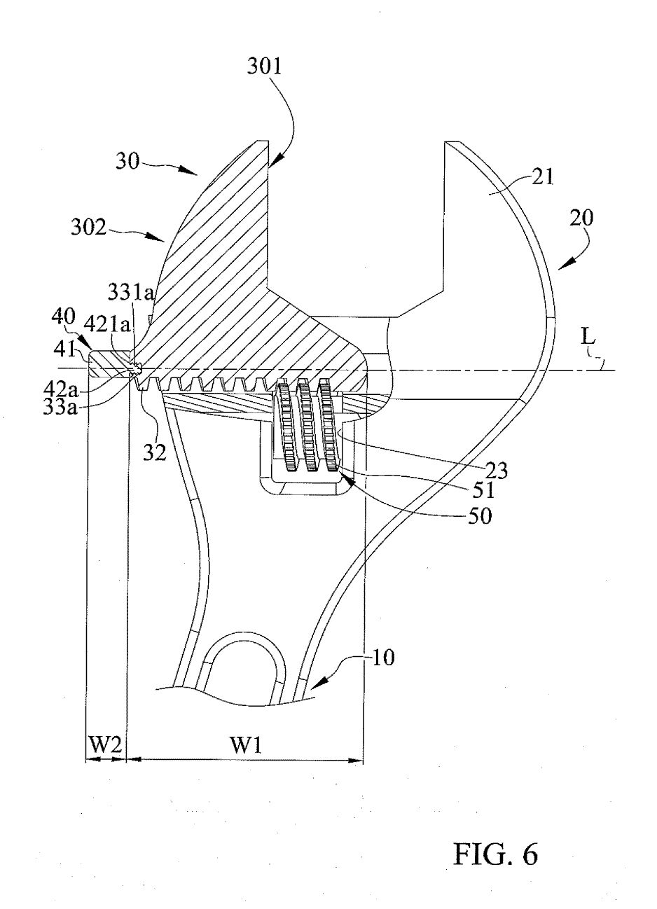

FIG. 6 shows an adjustable wrench of a second embodiment according to the present invention. The second embodiment is substantially the same as the first embodiment except that the first connecting portion 33a includes a first threaded section 331a formed around an inner periphery thereof. The second connecting portion 42a includes a second threaded section 421a formed around an outer periphery thereof and corresponding to the first threaded section 331a. The second threaded section 421a is detachably engaged with first threaded section 331a.

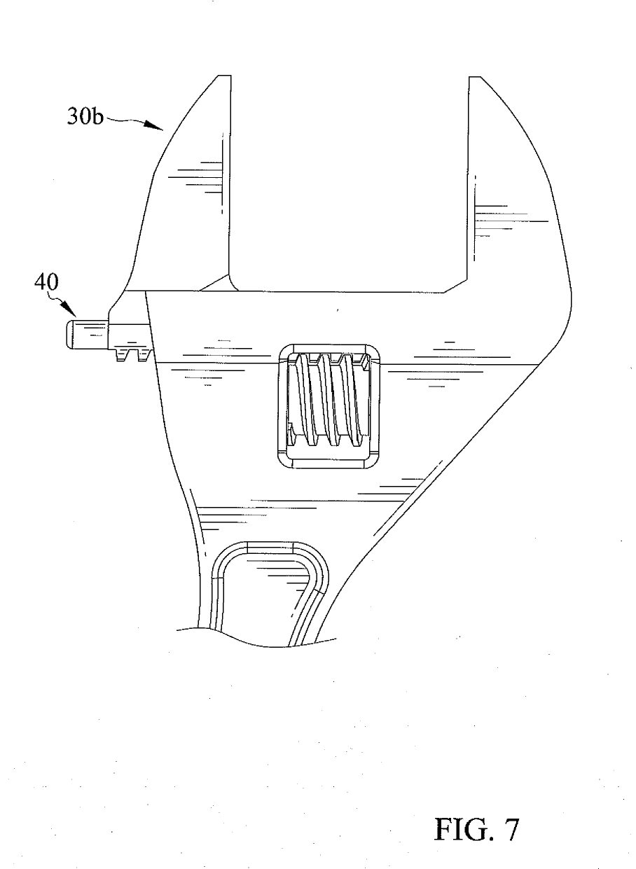

FIG. 7 shows an adjustable wrench of a third embodiment according to the present invention. The third embodiment is substantially the same as the first embodiment except that the bumper member 40 can be detachably connected to another type of the movable jaw 30b.

Although preferred embodiments of the present invention have been illustrated and described, they should not be construed to restrict the scope of the present invention. Therefore, modifications to numerical values or substitution of equivalent elements thereof or equivalent changes and modifications based on the accompanying claims of the present invention still fall within the scope covered by the present invention.

1. An adjustable wrench comprising:
a handle;
a head connected to an end of the handle, with the head including a fixed jaw, a guiding slot, and a receiving slot interconnected with the guiding slot;
a movable jaw slidably connected to the guiding slot along an axis, with the movable jaw including a first side and a second side spaced from the first side, with the first side facing to the fixed jaw, with the movable jaw further including a gripping portion, a guiding portion spaced from the gripping portion, and a first connecting portion formed in the guiding portion and located at the second side;
a bumper member including a bumper portion and a second connecting portion spaced from the bumper portion, with the second connecting portion detachably connected to the first connecting portion of the movable jaw; and
an adjusting assembly positioned in the receiving slot of the head and including a worm gear, with the worm gear engaged with the guiding portion of the movable jaw.

2. The adjustable wrench as claimed in claim 1, with the bumper member made of a nonmetal material.

3. The adjustable wrench as claimed in claim 1, with the bumper member made of an elastic material.

4. The adjustable wrench as claimed in claim 1, with the bumper portion and the second connecting portion connected with each other in one piece.

5. The adjustable wrench as claimed in claim 1, with the guiding portion of the movable jaw including a first width extending along the axis, with the bumper portion of bumper member including a second width extending along the axis, and with the first width greater than the second width.

6. The adjustable wrench as claimed in claim 5, with the ratio of the first width to the second width not less than 5.5.

7. The adjustable wrench as claimed in claim 5, with the ratio of the first width to the second width not less than 5.

8. The adjustable wrench as claimed in claim 1, with the first connecting portion of the movable jaw being a hole and extending from the second side to the first side, and with the second connecting portion of the bumper member being a protrusion extending from the bumper portion and corresponding to the first connecting portion.

9. The adjustable wrench as claimed in claim 8, with the first connecting portion including a first threaded section formed around an inner periphery thereof, with the second connecting portion including a second threaded section formed around an outer periphery thereof and corresponding to the first threaded section, and with the second threaded section detachably engaged with first threaded section.

10. The adjustable wrench as claimed in claim 1, with the bumper portion having a semicircular cross section perpendicular to the axis.
